(19) United States
(12) Patent Application Publication
(10) Pub. No.: US 2010/0048246 A1
(43) Pub. Date: Feb. 25, 2010

(54) MOBILE COMMUNICATION APPARATUS AND AUDIO SWITCHING METHOD

(76) Inventors: Ming YIN, Shanghai (CN); Po-Jen Cheng, Shanghai (CN)

Correspondence Address: BIRCH STEWART KOLASCH & BIRCH, PO BOX 747, FALLS CHURCH, VA, 22040-0747, US

(21) Appl. No.: 12/430,459

(22) Filed: Apr. 27, 2009

(30) Foreign Application Priority Data
Aug. 20, 2008 (TW) 097131701

(51) Int. Cl. H04M 1/00

(52) U.S. Cl. 455/557

(57) ABSTRACT

The invention includes a mobile communication apparatus and an audio switching method. The mobile communication apparatus according to the invention includes a receiver, a speaker, an optoelectronic sensing component, and a control unit. The optoelectronic sensing component is used to sense an environment state and generate an optical detection signal representing a result of sensing the environmental state. The control unit is coupled to the receiver, the speaker, and the optoelectronic sensing component. And, the control unit receives the optical detection signal and selectively outputs an audio signal via the receiver or the speaker according to the optical detection signal.

### BACKGROUND OF THE INVENTION

1. Field of the Invention

The invention relates to a mobile communication apparatus and an audio switching method. More particularly, the mobile communication apparatus and the audio switching method are capable of elevating the communicating efficiency of the mobile communication apparatus.

2. Description of the Prior Art

With the prosperous development of modern technology, the portable mobile communication apparatuses nowadays, e.g. mobile phones and personal digital assistants (PDA), have much more functionality in order to be competitive in the consumer market. For example, the present mobile phone usually has both of the earphone and the loudspeaker. The user may selectively answer the phone through the earphone or the loudspeaker.

However, the mobile phone is usually manually manipulated to select a mode of answering calls on the mobile phone through the earphone or through the loudspeaker, and the manual manipulation is just inconvenient. For example, when there is no time for the user to switch the mobile phone into the loudspeaker broadcasting mode in some urgent condition requiring the user to use both his hands and the mobile phone cannot be held or can barely be held approaching his ear, the user may be unable to perceive the broadcasted sound clearly and thus lose some important messages. In addition, it is a common experience for a user to hold the mobile phone by his neck and shoulder with both hands busy. Besides, broadcasting by the mobile phone through the loudspeaker broadcasting mode while the user's ear is close enough to the mobile phone would wastefully consume more electricity because the power consumption of the loudspeaker is much larger than that of the earphone.

The exchange of information is important in the modern society. The user is not willing to miss any information due to the fact that the mobile phone cannot be switched from the earphone broadcasting mode into the loudspeaker broadcasting mode in time. On the other hand, the user also is not willing to use or have the mobile phone standing by without sufficient electricity due to high power consumption caused by over heavily using the loudspeaker broadcasting mode.

Therefore, the invention discloses a mobile communication apparatus and an audio switching method, so as to solve said problems.

### SUMMARY OF THE INVENTION

An object of the invention is to provide a mobile communication apparatus.

A mobile communication apparatus according to the invention includes a receiver, a speaker, an optoelectronic sensing component, and a control unit. The optoelectronic sensing component is used for sensing an environmental state and generating an optical detection signal representing a result of sensing the environmental state. The control unit is coupled to the receiver, the speaker and the optoelectronic sensing component. The control unit receives the optical detection signal and selectively or optionally outputs an audio signal via the receiver or the speaker according to the optical detection signal.

An audio switching method according to the invention and suitable for a mobile communication apparatus comprising a receiver and a speaker includes the following steps: (a) sensing an environmental state and generating an optical detection signal representing a result of sensing the environmental state; and (b) selectively or optionally outputting an audio signal via the receiver or the speaker according to the optical detection signal.

The advantage and spirit of the invention may be better understood in view of the following detailed description together with the appended drawings.

### BRIEF DESCRIPTION OF THE APPENDED DRAWINGS

FIG. 1A is a functional block diagram illustrating a mobile communication apparatus according to an embodiment of the invention.

FIG. 1B is a functional block diagram illustrating an extended embodiment form the mobile communication apparatus shown in FIG. 1A.

FIG. 2 is an appearance schematic diagram illustrating a mobile communication apparatus according to an embodiment of the invention.

FIG. 3A is a flowchart illustrating an audio switching method according to an embodiment of the invention.

FIG. 3B is a flowchart illustrating an audio switching method according to another embodiment of the invention.

### DETAILED DESCRIPTION OF THE INVENTION

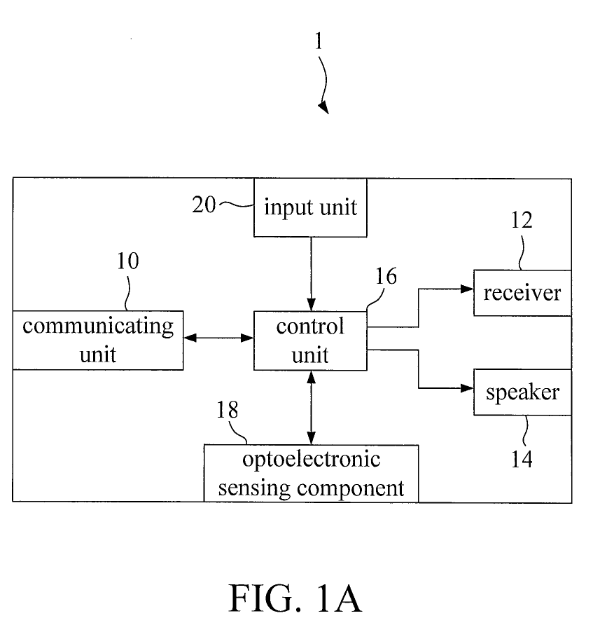

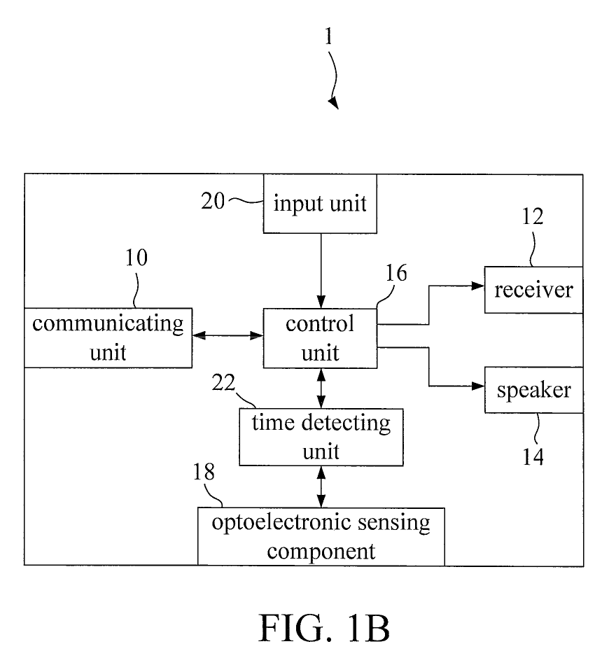

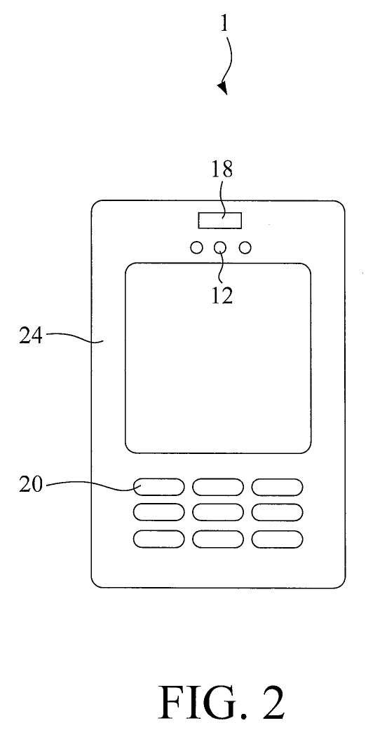

Please refer to FIG. 1A and FIG. 2. FIG. 1A is a functional block diagram illustrating a mobile communication apparatus 1 according to an embodiment of the invention. FIG. 2 is an appearance schematic diagram illustrating the mobile communication apparatus 1 according to an embodiment of the invention. In practical applications, the mobile communication apparatus 1 can be a mobile phone, a PDA phone, a smart phone, etc.

As shown in FIG. 1A, the mobile communication apparatus 1 includes a communicating unit 10, a receiver 12, a speaker 14, a control unit 16, an optoelectronic sensing component 18 and an input unit 20. As shown in FIG. 2, the mobile communication apparatus 1 has a casing 24, on which the input unit 20 is disposed. Besides, the receiver 12 and the optoelectronic sensing component 18 are disposed within the casing 24 and can be partly exposed out of an upper surface of the casing 24.

When the mobile communication apparatus 1 is utilized to answer a phone call, the communicating unit 10 can be used for receiving an audio signal, e.g. voice or music, from the phone call. The receiver 12 herein is an earphone of the mobile communication apparatus 1. After answering the phone call, the user may approach the earphone by his ear for listening to the audio signal. The speaker 14 in this embodiment comprises a loudspeaker of the mobile communication apparatus 1.

When the user wants to answer to the phone call, the user may transmit a manipulation signal to the control unit 16 through the input unit 20 (e.g. pressing an answer-key of the mobile phone). After the control unit 16 receives the manipulation signal from the answer-key, the control unit 16 controls the communicating unit 10 to receive the audio signal from the phone call according to the manipulation signal. At the same time, the control unit 16 may respond to the manipulation signal and activate the optoelectronic component 18.

The optoelectronic sensing component 18 is used for sensing an environmental state and generating an optical detection signal representing a result of sensing the environmental state. For example, the optoelectronic component can detect a variation of the environmental light or infrared radiation. There are two embodiments listed in the following paragraph for demonstrating the concept of the invention.

In the first embodiment, the optoelectronic sensing component 18 can include a photo diode.

When the user presses the answer-key, the circuit of photodiode is turned on. If the user does not approach the mobile communication apparatus 1 by his ear, e.g. when the mobile communication apparatus 1 is put on a table, the photodiode may detect the light from the surrounding environment. It is assumed that when the photodiode detects the light from the environment, the photodiode will send the optical detection signal, which is e.g. in a logic state of “1”, to the control unit 16. At this time, the control unit 16 broadcasts the audio signal, which is from the phone call and received by the communicating unit 10, via the loudspeaker. In brief, the broadcasting pattern of the mobile communication apparatus 1 under this condition would automatically switch to the loudspeaker, so as to make the audio signal clear to the user.

On the other hand, if the user holds the mobile communication apparatus 1 and approaches the earphone by his ear, the photodiode can only detect a weak light or even can not detect the environmental light at all. Under this condition, it is assumed that the photodiode sends the optical detection signal, which is e.g. in a logic state of “0”, to the control unit 16. At this time, the control unit 16 broadcasts the audio signal, which is from the phone call, via the earphone. That is to say, the broadcasting pattern of the mobile communication apparatus 1 would automatically switch from the loudspeaker to the earphone under this condition. The automatic switching function may prevent over consumption of the current for broadcasting the audio signal through the loudspeaker, so as to prolong the using time of the battery. Besides, when the user presses an end-key to terminate the phone call, the control unit 16 may respond to a manipulation signal generated by pressing the end-key and turns off the optoelectronic sensing component 18. Alternatively, the control unit 16 may automatically turn off the optoelectronic sensing component 18 when the phone call is ended by the caller.

In the second embodiment, the optoelectronic sensing component 18 can include an infrared radiation sensor.

When the user presses the answer-key, the circuit of the infrared radiation sensor is turned on, and at the same time, the infrared radiation sensor is triggered to emit infrared radiation. It is assumed that when the user does not approach the mobile communication apparatus 1 by his ear so that the infrared is not intercepted by the user, the infrared radiation sensor sends the optical detection signal, which is e.g. in a logic state of “1”, to the control unit 16. At this time, the control unit 16 broadcasts the audio signal, which is from the phone call, via the loudspeaker.

On the other hand, the user may hold the mobile communication apparatus 1 and approach the earphone by his ear so that the infrared is intercepted by the user. Under this condition, the infrared radiation sensor sends the optical detection signal, which is e.g. in a logic state of “0”, to the control unit 16. At this time, the control unit 16 broadcasts the audio signal, which is from the phone call, via the earphone.

Please refer to FIG. 1B. FIG. 1B is a functional block diagram illustrating an extended embodiment form the mobile communication apparatus 1 shown in FIG. 1A. As shown in FIG. 1B, the mobile communication apparatus 1 may further include a time detecting unit 22, which is coupled to the optoelectronic component 18 and the control unit 16. The time detecting unit 22 is used for detecting a switching time. The switching time indicates when to switch between two modes of outputting the audio signal. In this embodiment, these two modes are embodied as two broadcasting patterns, which may be the broadcasting pattern via the loudspeaker and the broadcasting pattern via the earphone.

For instance, it is assumed that the audio signal is broadcasted via the loudspeaker at the beginning. Once the optoelectronic sensing component 18 generates the optical detection signal in e.g. a logic state of “0”, the time detecting unit 22 begins to detect the switching time. As long as the switching time reaches a predetermined time, the optical detection signal in e.g. a logic state of “0” is transmitted to the control unit 16, for activating the broadcasting pattern to be switched from the loudspeaker to the earphone. The purpose of the design with the time detecting unit 22 is to avoid some unwanted situations, e.g. when the user briefly adjusts the gesture of holding the earphone, the mobile communication apparatus 1 may unnecessarily and annoyingly switch the broadcasting pattern into the loudspeaker. Besides, the design may prevent the dispensable waste of the electricity of the mobile communication apparatus 1.

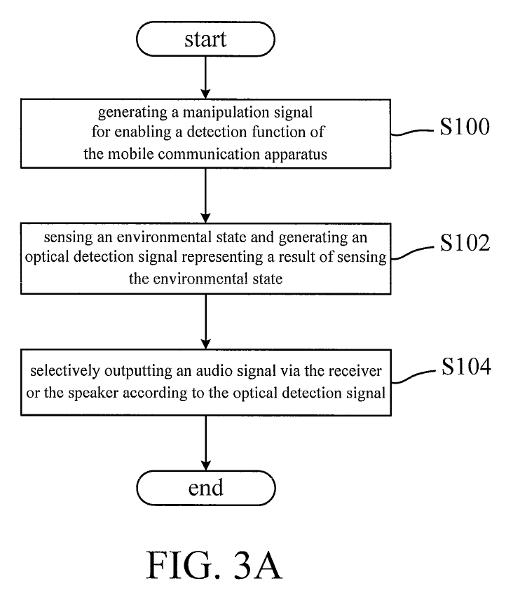

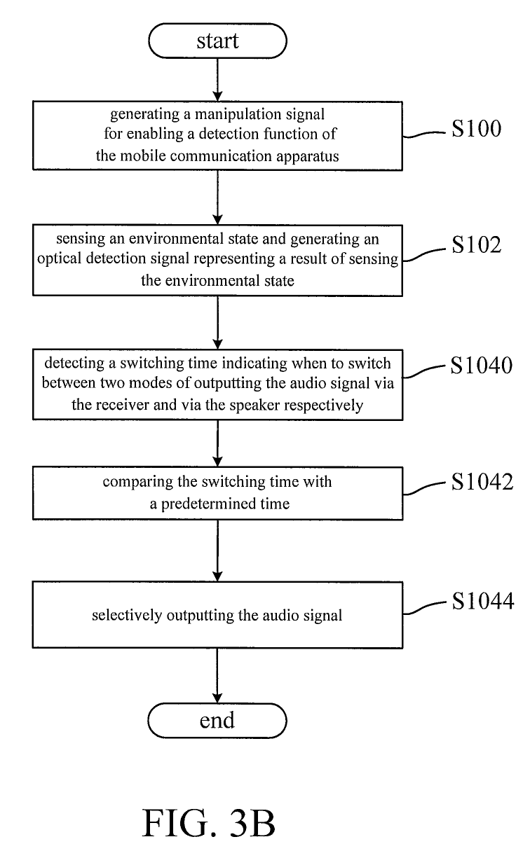

Please refer to FIG. 3A. FIG. 3A is a flowchart illustrating an audio switching method according to an embodiment of the invention. The audio switching method can be used on a mobile communication apparatus which includes a receiver and a speaker.

Step S100 is performed to generate a manipulation signal for enabling a detection function of the mobile communication apparatus. In step S100, the manipulation signal can be generated by an input unit of the mobile communication apparatus.

Step S102 is performed to sense an environmental state and generate an optical detection signal representing a result of sensing the environmental state. In this embodiment, the abovementioned detection function is to sense the environmental state. In practical applications, a variation of the environmental light or infrared radiation can be sensed in step S102.

Step S104 is performed to selectively or optionally output an audio signal via the receiver or the speaker according to the optical detection signal. As in the aforesaid description, if the optical detection signal in e.g. a logic state of “1” is generated, it broadcasts the audio signal via the speaker in step S104; otherwise, if the optical detection signal in e.g. a logic state of “0” is generated, it broadcasts the audio signal via the receiver in step S104.

Additionally, step S104 in FIG. 3A can be further separated into steps S1040˜S1044 in FIG. 3B.

Step S1040 is performed to detect a switching time indicating when to switch between two modes (i.e. broadcasting patterns) of outputting the audio signal via the receiver and via the speaker respectively. Afterward, step S1042 is performed to compare the switching time with a predetermined time. Afterward, step S1044 is performed to selectively or optionally broadcast the audio signal via the receiver or the speaker according to the judgment of the comparison in step S1042.

Compared with the prior art, the mobile communication apparatus and the audio switching method are capable of sensing the condition of the user while the phone call and then automatically switching the broadcasting patterns between the loudspeaker and the earphone. Therefore, the invention provides a more ergonomic communication design, so as to elevate the communicative efficiency of the mobile communication apparatus.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A mobile communication apparatus comprising:
a receiver;
a speaker;
an optoelectronic sensing component, for sensing an environmental state and generating an optical detection signal representing a result of sensing the environmental state; and
a control unit coupled to the receiver, the speaker and the optoelectronic sensing component, the control unit receiving the optical detection signal and selectively outputting an audio signal via the receiver or the speaker according to the optical detection signal.

2. The mobile communication apparatus of claim 1, further comprising:
a time detecting unit, coupled to the optoelectronic sensing component and the control unit, for detecting a switching time indicating when to switch between two modes of outputting the audio signal via the receiver and via the speaker respectively, wherein the control unit selectively outputting the audio signal according to the switching time.

3. The mobile communication apparatus of claim 1, further comprising:
an input unit, coupled to the control unit, for transmitting a manipulation signal to the control unit, wherein the control unit turning on or off the optoelectronic sensing component according to the manipulation signal.

4. The mobile communication apparatus of claim 1, wherein the optoelectronic sensing component is used for detecting an environmental light.

5. The mobile communication apparatus of claim 1, wherein the optoelectronic sensing component is used for detecting infrared radiation.

6. The mobile communication apparatus of claim 1, wherein the optoelectronic sensing component comprises a photodiode or an infrared radiation sensor.

7. The mobile communication apparatus of claim 1, wherein the optoelectronic sensing component is disposed near the receiver.

8. An audio switching method suitable for a mobile communication apparatus, the mobile communication apparatus comprising a receiver and a speaker, the method comprising steps of:
(a) sensing an environmental state and generating an optical detection signal representing a result of sensing the environmental state; and
(b) selectively outputting an audio signal via the receiver or the speaker according to the optical detection signal.

9. The audio switching method of claim 8, wherein before the step (a), the audio switching method comprises the step of:
(c) generating a manipulation signal for enabling the step of sensing the environmental state.

10. The audio switching method of claim 9, wherein the audio switching method utilizes an input unit of the mobile communication apparatus for generating the manipulation signal in the step (c).

11. The audio switching method of claim 8, wherein the step (b) further comprises steps of:
(b1) detecting a switching time indicating when to switch between two modes of outputting the audio signal via the receiver and via the speaker respectively; and
(b2) comparing the switching time with a predetermined time and selectively outputting the audio signal.

12. The audio switching method of claim 8, wherein the step (a) comprises detecting an environmental light.

13. The audio switching method of claim 8, wherein the step (a) comprises detecting infrared radiation.
